(19) United States
(12) Patent Application Publication
(10) Pub. No.: US 2025/0166624 A1
(43) Pub. Date: May 22, 2025

(54) METHODS AND SYSTEMS FOR IN-RECORDING CONTENT EDITING VIA VOICE EDIT COMMANDS

(71) Applicant: DRAKE PROFESSIONAL SERVICES, LLC, Eastham, MA (US)

(72) Inventor: Ian Drake, Eastham, MA (US)

(21) Appl. No.: 18/517,840

(22) Filed: Nov. 22, 2023

(51) Int. Cl. G10L 15/22; G10L 15/04; G10L 15/26; G10L 25/60

(52) U.S. Cl. CPC G10L 15/22; G10L 15/04; G10L 15/26; G10L 25/60; G10L 2015/223

(57) ABSTRACT

Systems and methods for dynamically and automatically editing a content recording based on user-provided voice commands. Audio of the content recording is converted to text and analyzed to identify one or more voice commands of the user. An action to perform on the content recording is determined based on the one or more voice commands. And the action is automatically performed on the content recording in response to identifying the one or more voice commands in the text of the audio of the content recording.

### TECHNICAL FIELD

The present application pertains to content editing, and more particularly, to automatically editing audiovisual content using real-time voice commands uttered when the content was recorded.

### BACKGROUND

### Description of the Related Art

Many people take a lot of long videos when trying to capture a specific moment. The number or length of these videos can greatly increase when multiple takes are captured. As a result, people may spend a lot of time sifting through the raw footage to identify usable sections. Unfortunately, this practice can be time-consuming and can cause the person to miss some usable sections. It is with respect to these and other considerations that the embodiments described herein have been made.

### BRIEF SUMMARY

Briefly stated, embodiments are directed towards systems and methods that enable users to verbally or audibly issue or utter editing commands during the real-time recording of content. Post-recording, or in real-time during recording in some embodiments, these commands are detected and processed to cause actions to be automatically implemented on the content recording.

More specifically, a content recording is obtained, and an audio portion of the content recording is converted to text. This text is analyzed to identify one or more voice commands of the user. An action to perform on the content recording is then determined based on the one or more voice commands. The action is automatically performed on the content recording in response to identifying the one or more voice commands in the text of the audio of the content recording.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of a non-limiting embodiment of systems that provide functionality to automatically edit a content recording based on voice commands uttered in real time during the recording of the content in accordance with embodiments described herein;

FIG. 2 illustrates a logical flow diagram generally showing one embodiment of an overview process to automatically edit a content recording based on voice commands uttered in real time during the recording of the content in accordance with embodiments described herein;

FIGS. 3-5 illustrate logical flow diagrams generally showing embodiments of processes for determining an action to perform on a content recording based on a voice command uttered in real time during the recording of the content in accordance with embodiments described herein; and

FIG. 6 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

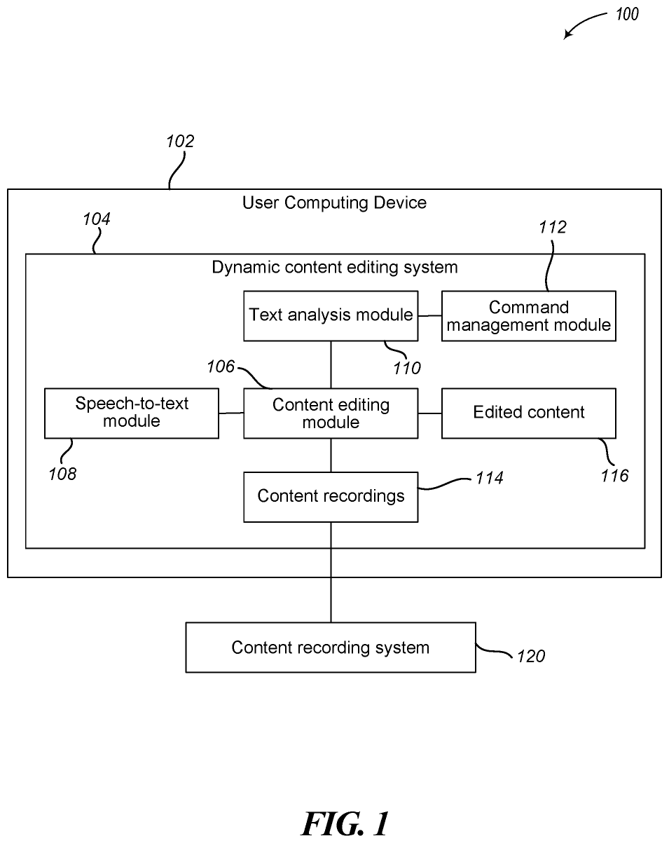

FIG. 1 illustrates a context diagram of a non-limiting embodiment of systems 100 that provide functionality to automatically edit a content recording based on voice commands uttered in real time during the recording of the content in accordance with embodiments described herein.

System 100 includes a user computing device 102 and a content recording system 120. Although FIG. 1 illustrates the content recording system 120 as being separate and independent of user computing device 102, embodiments are not so limited. Rather, in some embodiments, the content recording system 120 may be included within or integrated with the user computing device 102.

The content recording system 120 is configured to capture or record content and store a content recording. Examples of the content recording system 120 may include, but are not limited to, camcorders, dashcams, body cams, personal computing devices, tablet computers, smartphones, or other computing devices having or receiving input from a camera or microphone, or both. In various embodiments, the content recording may be a representation of video or audio data in a format that can be processed or played by computers or digital devices. This content recording can be originally captured in a digital format or might be converted from an analog source.

In some embodiments, a user may capture one or a plurality of content recordings using the content recording system 120. As the content recording is being captured and stored in real time by the content recording system 120, the user can utter or say one or more voice commands. Examples of such voice commands may include, but are not limited to, “cut,” “keep,” “clip [TimeFrame],” “effect [EffectName],” “segment [SegmentName],” “better/best/favorite,” “comment [CommentContent],” “end,” etc. The cut command eliminates a corresponding portion from the content recording from the previous or last command (or the start of the content recording if the cut command the first command). The keep command preserves a corresponding portion of the content recording from the previous or last command (or the start of the content recording if the keep command the first command). The clip command saves a specified duration of a corresponding portion of the content recording. In some embodiments, the user can state the duration, [TimeFrame], when uttering the clip command. If no duration is specified, a default duration may be used. The effect command indicates a specific effect, [EffectName], to perform on the content starting from the command and used for some period, such as until an overriding effect command is given. The segment command commences a named, [SegmentName], corresponding portion of the content recording. If no segment name is given, a default name may be used. In some embodiments, a segment count may also be used with the default name or if the user utters the same segment name. The better/best/favorite command, also referred to as a quality command, labels a corresponding portion of the content recording according to the command relative to other portions of the content recording or other content recordings. For example, a better command labels that corresponding portion of the content recording as being superior to a prior portion, but a best command labels that corresponding portion of the content recording as being of even higher superiority. The best command or a favorite command can be used to label that corresponding portion of the content recording as being favored by the user, which can be used to store a favorites list. The comment command introduces a user-provided comment, [CommentContent]. The end command closes a previous command that was started, such as a segment command or a comment command.

The user computing device 102 includes a dynamic content editing system 104 that is configured to obtain a content recording from the content recording system 120 and analyze the content recording to detect the commands uttered by the user during the recording of the content. The dynamic content editing system 104 is further configured to automatically perform one or more actions on the content recording based on the detected commands. Examples of the user computing device 102 may include, but are not limited to, desktop computers, laptop computers, smartphones, server computers, cloud computing resources, or other computing systems utilized by a user to edit a content recording.

The dynamic content editing system 104 stores content recordings 114 received from the content recording system 120. The dynamic content editing system 104 also includes a content editing module 106, a speech-to-text module 108, a text analysis module 110, and command management module 112.

The content editing module 106 is configured to obtain one or more content recordings from the content recordings 114 and perform actions on the content or the content recording based on user-uttered voice commands detected within the content recording. In various embodiments, the content editing module 106 extracts an audio portion of the content recording and provides it to the speech-to-text module 108. The content editing module 106 may then receive a file of text detected within the audio portion of the content recording. The content editing module 106 provides the text to the text analysis module 110 and receives one or more voice commands detected within the content recording. The content editing module 106 can then determine which action to perform on the content recording based on the command and perform or implement the action. In some embodiments, the content editing module 106 may store clips or segments, or other data, in the edited content 116.

The speech-to-text module 108 is configured to receive an audio portion of the content recording from the content editing module 106. The speech-to-text module 108 converts speech within the audio portion of the content recording into text. In some embodiments, the speech-to-text module 108 identifies timestamps or other indicators of each word or phrase in the text. In this way, the content editing module 106 can determine when a command occurred within the content recording and more accurately perform a corresponding action on the content recording.

The text analysis module 110 is configured to receive the text portion of the content recording from the content editing module 106. The text analysis module 110 analyzes the text to identify and track voice commands uttered by a user. In various embodiments, the text analysis module 110 coordinates with the command management module 112 to determine if one or more commands are present in the text. If a command is detected, the text analysis module 110 provides those commands to the content editing module 106.

The command management module 112 is configured to maintain commands for a user. In some embodiments, the command management module 112 stores a list of possible commands. In at least one embodiment, these possible commands may be pre-set or pre-defined for the user. In other embodiments, the command management module 112 may utilize one or more machine learning or artificial intelligence mechanism to learn user-specific commands.

Although the content editing module 106, the speech-to-text module 108, the text analysis module 110, and the command management module 112 are illustrated separately, embodiments are not so limited. Rather, the functionality of the content editing module 106, the speech-to-text module 108, the text analysis module 110, and the command management module 112 may be implemented by a single module or a plurality of modules.

Moreover, the user that utters voice commands in real time during the recording of content may be the same user or a different user from the user who utilizes the user computing device 102 to have automatic actions performed on the content recording based on those commands.

Furthermore, although the dynamic content editing system 104 is described as analyzing the content recording for voice commands, embodiments are not so limited. Rather, in some embodiments, distinguishable tones or non-word audible sounds may be used as commands. In other embodiments, visual gestures may be used as commands. Accordingly, the dynamic content editing system 104 may employ different modules to perform slightly different functions for these other types of commands.

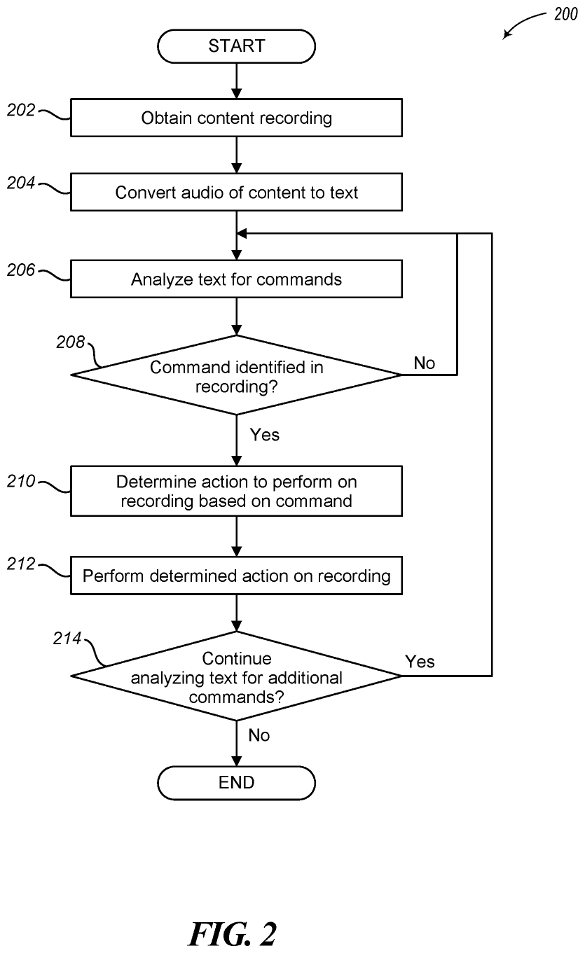

The operation of certain aspects of the disclosure will now be described with respect to FIGS. 2-5. In at least one of various embodiments, processes 200, 300, 400, and 500 described in conjunction with FIGS. 2-5, respectively, may be implemented by or executed via circuitry or by a system of one or more computing devices, such as user computing device 102 in FIG. 1.

FIG. 2 illustrates a logical flow diagram generally showing one embodiment of an overview process 200 to automatically edit a content recording based on voice commands uttered in real time during the recording of the content in accordance with embodiments described herein.

Process 200 begins, after a start block, at block 202 where a content recording is obtained. As discussed herein, the content recording may be an audiovisual content recording, an audio only content recording, or a visual only content recording.

In some embodiments, a single content recording (or single content file) is obtained. In other embodiments, a plurality of content recordings (or a plurality of content files) are obtained. In at least one such embodiment, the plurality of content recordings may be aggregated, combined, or opened as a single content recording. For example, a plurality of sequentially recorded videos may be aggregated and considered or analyzed as a single video recording.

Process 200 proceeds after block 202 to block 204, where an audio portion of the content recording is converted to text. In some embodiments, an audio file or audio stream associated with the content recording may be obtained or extracted from the content recording. One or more speech-to-text algorithms or mechanisms may be utilized to convert the audio portion into text.

Process 200 continues after block 204 at block 206, where the text is analyzed for commands that were uttered in real time by a person or user during the recording of the content. In various embodiments, the text, or a section of the text, may be compared to a list of possible voice commands. As discussed in more detail herein, the command may be a single word, a phrase of multiple words uttered together (e.g., within a threshold amount of time), multiple words or phrases uttered separately (e.g., separated by at least a threshold amount of time or defined as a start command followed by an end command), or other voice commands.

In some embodiments, the list of possible voice commands may be pre-set or pre-defined by the user or an administrator. In other embodiments, the list of possible voice commands can be learned over time based on words uttered by the user in real time during the recording of the content in combination with post-processing manual edits made to the content recording by the user. In various embodiments, one or more machine learning or artificial intelligence mechanisms may be employed to train a model to identify these possible voice commands. In at least one such embodiment, the words uttered by the user in real time during the recording of the content and the post-processing manual edits made to the content recording by the user may be used as inputs to train the model.

In various embodiments, the text may be analyzed sequentially in a same time sequence as a video portion of the content recording. If a command is identified in the text, a corresponding timestamp of the word relative to the content recording is obtained. In this way, the position in the content recording of when the user uttered the command is determined. In various embodiments, the content recording, or another file, may identify timestamps or time codes within the content recording. These time codes may be a sequence of numeric values generated at regular intervals to provide a time reference for video or audio material. Time codes enable precise synchronization and locating of specific frames or moments in a content recording.

In some embodiments, the user may set the analysis to consider non-word sections of the content recording. For example, the user may want to cut portions of the content recording where there is mumbling, quiet space (e.g., no speaking for a threshold amount of time), unintelligible audio, etc. In this way, the system can generate a cut command in response to identifying a non-word portion of the content recording. This situation can be beneficial where the content recording is an audio file of a podcast where the user intends to speak nearly the entire length of the podcast.

Process 200 proceeds next after block 206 to decision block 208, where a determination is made whether a command is identified. In various embodiments, this determination may be made whether the analysis of a section of the text results in a match to a command in the list of possible commands. If a command is identified, then process 200 proceeds to block 210, otherwise, process 300 loops to block 206 to continue to analyze a next section of the text for commands.

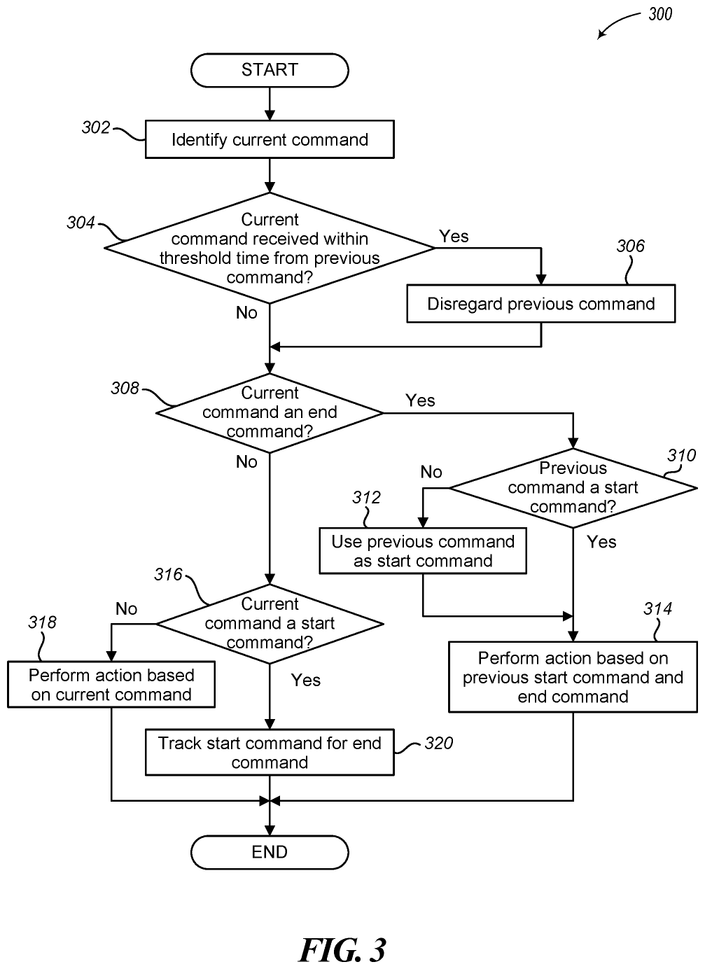

At block 210, an action to perform on the content recording is determined based on the identified command. Various embodiments of determining the action to perform on the content recording is described in more detail below in conjunction with FIGS. 3-5. Briefly, however, the action performed on the content recording may include, generating a segment, keeping (or preserving) an identified portion of the content recording, cutting (or removing) an identified portion of the content recording, capturing a comment from the user from the identified portion of the text associated with the content recording, initiating an effect to the content, labeling an identified portion of the content recording with a quality designation, clipping (or generating) a new file for an identified portion of the content recording, etc. In various embodiments, the action may be performed based on the current command or a combination of the current command and a previous command.

After block 210, process 200 proceeds to block 212, where the determined action is performed on the recording. Various embodiments of performing the action on the content recording is described in more detail below in conjunction with FIGS. 3-5.

Process 200 proceeds after block 212 to decision block 214 to determine if the analysis of the text for additional commands is to be continued. In some embodiments, the identified command may be a start command. Thus, the text may continue to be analyzed for an end command. In other embodiments, the text may continue to be analyzed for commands until the end of the text (and thus the end of the content recording) is analyzed for commands. If the analysis of the text is to continue, process 200 loops to block 206; otherwise, process 200 ends or returns to a calling process to perform other actions.

FIG. 3 illustrates a logical flow diagram generally showing an embodiment of a process 300 for determining an action to perform on a content recording based on a voice command uttered in real time during the recording of the content in accordance with embodiments described herein.

Process 300 begins, after a start block, at block 302, where a current command is identified. In various embodiments, the current command may be the command determined to be identified at decision block 208 in FIG. 2.

Process 300 proceeds after block 302 to decision block 304, where a determination is made whether the current command was received within a threshold time from a previous command. In this way, the current command overrides the previous command. The threshold time may be set by the user or an administrator.

In at least one embodiment, this determination may be made by comparing a first timestamp of the previous command to a second timestamp of the current command. If a difference between the first and second timestamps exceeds the threshold time, then the current command overrides the previous command. If the current command overrides the previous command, process 300 flows to block 306; otherwise, process 300 flows to decision block 308.

At block 306, the previous command is disregarded. In this way, the previous command is not performed or considered in determining what action to perform on the content recording. After block 306, process 300 proceeds to decision block 308.

At decision block 308, a determination is made whether the current command is an end command. In some embodiments, the end command may be identified by the user uttering the word “end.” In other embodiments, the end command may be identified by the user uttering a specific command that is interpreted as an end command, such as “segment,” “keep,” “cut,” “comment,” etc. If the current command is an end command, process 300 flows to decision block 310; otherwise, process 300 flows to decision block 316.

At decision block 310, a determination is made whether the previous command is a start command. In some embodiments, the previous command may be an explicit command to start a specific section or portion of the content recording, start a user-provided (or user-uttered) segment or comment, or start some other commanded action. If the previous command is a start command, then process 300 flows to block 314; otherwise, process 300 flows to block 312.

At block 312, the previous command may be used as a start command, even though it may not have been an explicit start command. In some embodiments, the previous command used as the start command may be the command sequentially prior to the current end command. For example, the previous command may be an adjacent previous end command for a previous action. In this instance, the previous end command may also act as the start command to a current end command. In other embodiments, the previous command used as the start command may be a prior command that is not sequentially prior to or adjacent to the current end command. In at least one such embodiment, some previous commands may be ignored or skipped as the start command based on the type of previous command. After block 312, process 300 proceeds to block 314.

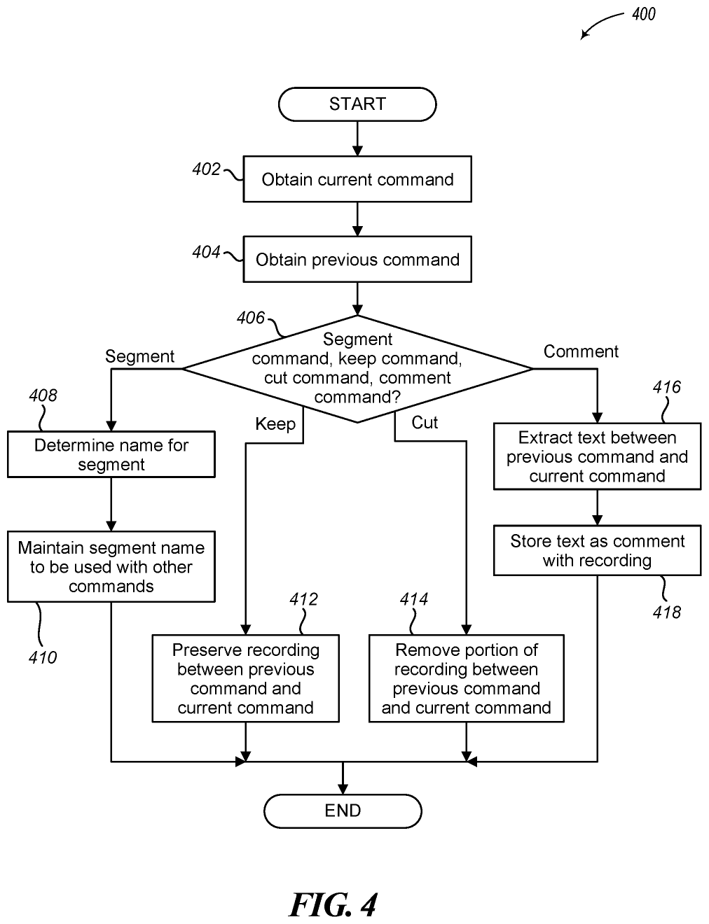

At block 314, an action is performed on the content recording based on the previous start command and the current end command, which is described in more detail below in conjunction with FIG. 4. After block 314, process 300 terminates and returns to a calling process, such as returning to decision block 214 in FIG. 2.

If, at decision block 308, the current command is not an end command, then process 300 flows from decision block 308 to decision block 316.

At decision block 316, a determination is made whether the current command is a start command. In some embodiments, the current command may explicitly indicate a start of a segment, comment, or specific section or portion of the content to perform an action. If the current command is a start command, then process 300 flows to block 320; otherwise, process 300 flows to block 318. At block 320, the start command is tracked for an end command. In various embodiments, the text of the content recording is continuously analyzed (e.g., at block 206) for an end command. In at least one embodiment, the start command is stored as a previous command for a next current command identified during the continued analysis of the text in the content recording. After block 320, process 300 terminates and returns to a calling process, such as returning to decision block 214 in FIG. 2.

If, at decision block 316, the current command is not a start command, then process 300 flows from decision block 316 to block 318.

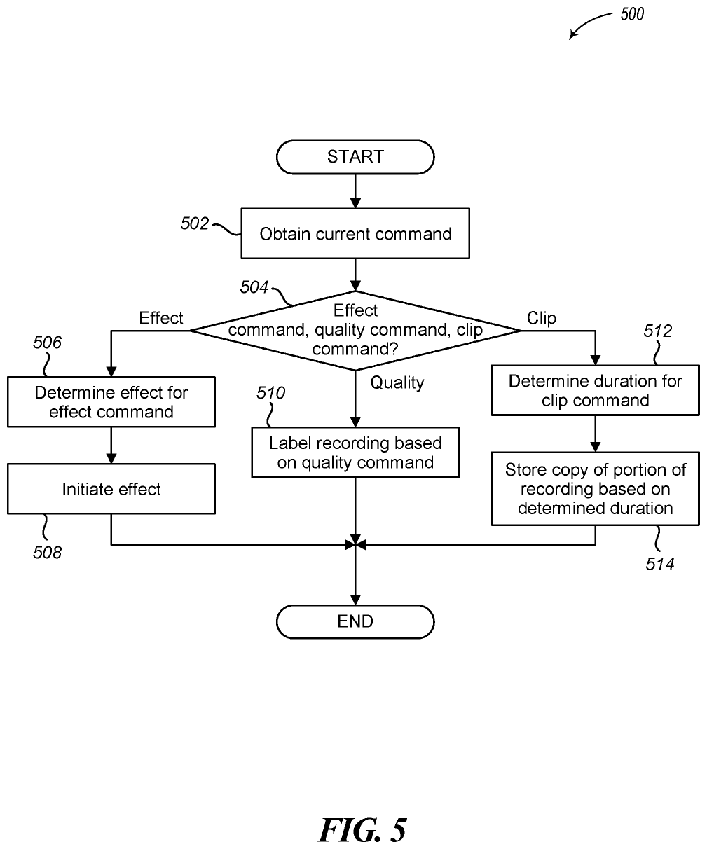

At block 318, an action is performed on the content recording based on the current command, which is described in more detail below in conjunction with FIG. 5. After block 318, process 300 terminates and returns to a calling process, such as returning to decision block 214 in FIG. 2.

FIG. 4 illustrates a logical flow diagram generally showing an embodiment of a process 400 for determining an action to perform on a content recording based on a current and previous voice command uttered in real time during the recording of the content in accordance with embodiments described herein.

Process 400 begins, after a start block, at block 402, where a current command is obtained. In various embodiments, the current command is the end command (i.e., the current end command) determined at decision block 308 in FIG. 3. In various embodiments, the current command includes or is associated with a timestamp of when the current command was uttered in the content recording. In some embodiments, this timestamp may be referred to as the end timestamp.

Process 400 proceeds after block 402 to block 404, where a previous command is obtained. In various embodiments, the previous command is a start command (i.e., the previous start command) determined at decision block 310 or block 312 in FIG. 3. In various embodiments, the previous command includes or is associated with a timestamp of when the previous command was uttered in the content recording. In some embodiments, this timestamp may be referred to as the start timestamp.

Process 400 continues after block 404 at decision block 406, where a determination is made whether the current and previous commands correspond to a segment command, a keep command, a cut command, or a comment command.

If the current and previous commands correspond to a segment command, process 400 flows from decision block 406 to block 408.

At block 408, a name for the segment is determined. In various embodiments, the text corresponding to the content recording between the previous command and the current command may be utilized as the segment name. If no segment name is uttered or identifiable from the text, then a default name may be used. In some embodiments, an offset may be used to adjust the text used to identify the segment name relative to the start timestamp or the end timestamp, or both. The offset may be prior to a timestamp associated with a command or it may be after a timestamp associated with a command, similar to the offset described below in conjunction with block 412.

Process 400 proceeds after block 408 to block 410, where the segment name is maintained for use with other commands identified in the content recording. For example, assume the text of the content recording states: “Segment command part one, introduction. End command. How long does it take to drive from Denver, Colorado to Phoenix, Arizona? Keep command. It depends on which route you take, but it is over 12 hours. Keep command.” In this example, the segment name is extracted as “part one introduction”. From that point in the content recording, every recording kept or clipped is given that segment name. In some embodiments, a segment override command may be used to terminate use of the currently maintained segment name.

After block 410, process 400 terminates and returns to a calling process to perform other actions.

If, at decision block 406, the current and previous commands correspond to a keep command, process 400 flows from decision block 406 to block 412.

At block 412, the content between, or associated with, the previous command and the current command is preserved or labeled to be kept. In at least one embodiment, the kept portion may be identified within the content recording starting at the start timestamp associated with the previous command and stopping at that end timestamp associated with the current command.

In other embodiments, an offset may be used to adjust the kept portion relative to the start timestamp or the end timestamp, or both. The offset may be prior to a timestamp associated with a command or it may be after a timestamp associated with a command. For example, a first offset (or start command's offset) may be set to be prior to the start timestamp, or the first offset may be set to be after the start timestamp. Likewise, a second offset (or end command's offset) may be set to be prior to the end timestamp, or the second offset may be set to be after the end timestamp. In some situations, only the first offset it utilized. In other situations, only the second offset is utilized. And in yet other situations, both the first offset and the second offset are utilized. In this way, the kept portion of the content recording may include more content just prior to or less content just after the previous command (e.g., the start command), less content just prior to or more content just after the current command (e.g., the end command), or both.

In various embodiments, one or more offsets may be set by the user. For example, if the kept portion is consistently including part of the command and the user does not want the kept portion to include the command, then the user can set the end command's offset to “−0.25,” which will adjust the end command's timestamp backwards a quarter second and produce the desired output. Likewise, if the user wants the kept portion to include the command, then the user can set the end command's offset to “+0.25,” which will adjust the end command's timestamp forward a quarter second and produce this alternative desired output.

If a previous command was a segment command and a segment name is being maintained, then the kept portion may be titled, labeled, or stored using the maintained segment name. In some embodiments, the segment name may also include a count such that each time the kept command is identified after the segment command, then the same segment name is used and the count is increased. In this way, a segment can be made up of one or more kept portions and can be named for easier identification.

After block 412, process 400 terminates and returns to a calling process to perform other actions.

If, at decision block 406, the current and previous commands correspond to a cut command, process 400 flows from decision block 406 to block 414.

At block 414, the content between, or associated with, the previous command and the current command is cut or removed from the content recording. In at least one embodiment, the cut portion may start at the start timestamp associated with the previous command and stop at that end timestamp associated with the current command. In other embodiments, an offset may be used to adjust the cut portion relative to the start timestamp or the end timestamp, or both. The offset may be prior to a timestamp associated with a command or it may be after a timestamp associated with a command, similar to the offset described above in conjunction with block 412. After block 414, process 400 terminates and returns to a calling process to perform other actions.

If, at decision block 406, the current and previous commands correspond to a comment command, process 400 flows from decision block 406 to block 416.

At block 416, text between the previous command and the current command are extracted. In at least one embodiment, the text portion used as the comment may be identified from the text starting at the start timestamp associated with the previous command and stopping at that end timestamp associated with the current command. In other embodiments, an offset may be used to adjust the text portion used as the comment relative to the start timestamp or the end timestamp, or both. The offset may be prior to a timestamp associated with a command or it may be after a timestamp associated with a command, similar to the offset described above in conjunction with block 412.

In some other embodiments, the user may utter other types of label-related commands. For example, in some embodiments, the comment may be a tag or other label that can be used to associate separate content recordings with one another.

Process 400 proceeds after block 416 to block 418, where the text is stored as a comment with the content recording. In some embodiments, the comment is stored as metadata of the content recording. In other embodiments, the comment is stored in a separate file, such as a text document. After block 418, process 400 terminates and returns to a calling process to perform other actions.

FIG. 5 illustrates a logical flow diagram generally showing an embodiment of a process 500 for determining an action to perform on a content recording based on a current voice command uttered during the recording of the content in accordance with embodiments described herein.

Process 500 begins, after a start block, at block 502, where a current command is obtained. In various embodiments, the current command includes or is associated with a timestamp of when the current command was uttered in the content recording. In some embodiments, this timestamp may be referred to as the command timestamp.

Process 500 proceeds after block 502 at decision block 504, where a determination is made whether the current command is an effect command, a quality command, or a clip command.

If the current command is an effect command, process 500 flows from decision block 504 to block 506.

At block 506, an effect for the command is determined. In various embodiments, the text associated with the command may indicate the type of effect that is to be performed on the content of the recording. Examples of the effect may include zoom in, zoom out, fade in, fade out, changes in contrast, changes in color, changes in volume, etc.

In some embodiments, the duration of the effect may be pre-set by the user or by an administrator. In other embodiments, different types of effects may have separate default durations. In some other embodiments, the duration may not be set such that the effect continues until the user utters another command. In yet other embodiments, the duration of the effect may be defined by the user during the uttering of the command. For example, the user could say “zoom in 10” to have the content zoomed in over a 10 second period. Similarly, the user can define other characters of the effect. For example, the user could change how much zoom is applied by saying “zoom 150%” or zoom 120%.”

Process 500 proceeds after block 506 to block 508, where the effect is implemented. After the effect is implemented on the content, the content recording is stored to maintain the effect. After block 508, process 500 terminates and returns to a calling process to perform other actions.

If, at decision block 504, the current command is a quality command, process 500 flows from decision block 504 to block 510.

At block 510, the content recording is labeled based on the quality command. In various embodiments, quality command may indicate the user's desire or likeness of a particular portion of the content. Examples of quality commands may be “better,” “best,” “favorite” “dislike,” “worse,” etc. In this way, the user can maintain their impression of the content recording while the content is being recorded. In some situations, the user can use the quality command to save the content recording to a favorites list. After block 510, process 500 terminates and returns to a calling process to perform other actions.

If, at decision block 504, the current command is a clip command, process 500 flows from decision block 504 to block 512.

At block 512, a duration indicating an amount (e.g., portion size) of the content to copy as a new file prior to the current command is determined. In some embodiments, the duration may be pre-set by the user or by an administrator. In other embodiments, the duration of the clip may be defined by the user during the uttering of the command. For example, the user could say “clip 10 seconds” to have the last 10 seconds of content clipped and saved as a new file. In other embodiments, a default duration may be used if the user does not utter a duration with the command. In other embodiments, a previous command may be utilized to define the duration of the clip, such that the portion of the content recording between the previous command and the clip command is clipped and copied.

Process 500 proceeds after block 512 to block 514, where a copy of the content recording defined by the duration preceding the current command is stored. In various embodiments, this copy is stored as a new file. In some embodiments, the new file may be named with a default name. In other embodiments, the user may utter a name that is to be used to name the new file.

If a previous command was a segment command and a segment name is being maintained, then the copied or clipped portion may be titled, labeled, or stored using the maintained segment name. As mentioned above, the segment name may also include a count such that each time the clip command is identified after the segment command, then the same segment name is used and the count is increased. In this way, a segment can be made up of one or more clipped portions and can be named for easier identification.

After block 515, process 500 terminates and returns to a calling process to perform other actions.

Although FIGS. 2-5 describe embodiments of performing actions sequentially on the content recording, embodiments are not so limiting. Rather, in some embodiments, commands may be embedded (or nested) within one another. For example, the user can utter a quality command followed by a clip command. In this instance, the quality command may not be considered as the start command indicating a start of the portion of the content recording that is to be clipped. Rather, the quality command may be imbedded within the clip command so that the clipped content also includes the quality label. Accordingly, a plurality of actions for a plurality of commands may be performed chronologically on the content recording, overlapping on the content recording, or embedded.

Moreover, although FIGS. 2-5 describe embodiments of analyzing text of voice commands to determine which action or actions to perform on the content recording, embodiments are not so limiting. Rather, in some embodiments, other audible, non-word, commands may be analyzed to determine which action or actions to perform on the content recording, as described herein. For example, a user may utter tones, notes, or otherwise make specific noises (e.g., the user may whistle or clap), where different utterances or noises designate different commands. In yet other embodiments, visual gestures may be analyzed to determine which action or actions to perform on the content recording, as described herein. For example, the user can flash a thumbs up, thumbs down, horizontal hand swipe, etc., where different gestures designate different commands.

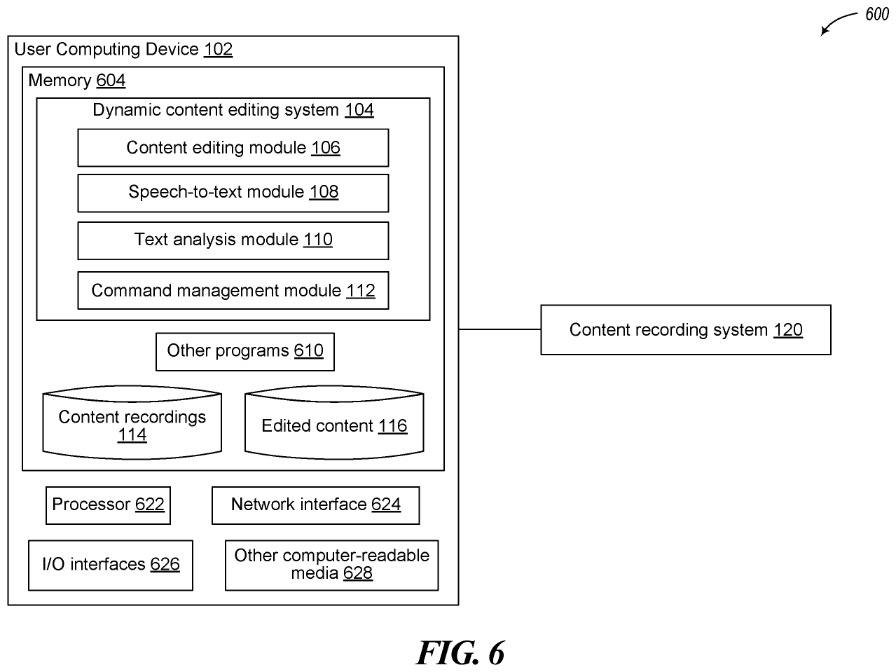

FIG. 6 shows a system diagram that describes one implementation of computing systems for implementing embodiments described herein. System 600 includes user computing device 102 and content recording system 120.

The content recording system 120 is configured to capture or record content, such that the user can provide voice commands while the content is being recorded for future editing. As described herein, the content recording system 120 may be a computing device or computing system that is separate and distinct from the user computing device 102, or the content recording system 120 may be part of or included with or embedded in user computing device 102.

As described herein, the user computing device 102 is a computing device that can perform functionality described herein for detecting voice commands within a content recording to automatically edit, modify, or perform an action on the content recording. One or more special purpose computing systems may be used to implement the user computing device 102. Accordingly, various embodiments described herein may be implemented in software, hardware, firmware, or in some combination thereof. The user computing device 102 includes memory 604, processor 622, network interface 624, input/output (I/O) interfaces 626, and other computer-readable media 628.

Processor 622 includes one or more processors, processing units, programmable logic, circuitry, or other computing components that are configured to perform embodiments described herein or to execute computer instructions to perform embodiments described herein. In some embodiments, processor 622 may include a single processor that operates individually to perform actions. In other embodiments, processor 622 may include a plurality of processors that operate to collectively perform actions, such that one or more processors may operate to perform some, but not all, of such actions. Reference herein to “a processor system” refers to one or more processors 622 that individually or collectively perform actions. And reference herein to “the processor system” refers 1) a subset or all of the one or more processors 622 comprised by “a processor system” and 2) any combination of the one or more processors 622 comprised by “a processor system” and one or more other processors 622.

Memory 604 may include one or more various types of non-volatile or volatile storage technologies. Examples of memory 604 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 604 may be utilized to store information, including computer-readable instructions that are utilized by processor 622 to perform actions, including at least some embodiments described herein.

Memory 604 may have stored thereon dynamic content editing system 104, which is configured to perform embodiments described herein. The dynamic content editing system 104 may include content editing module 106, speech-to-text module 108, text analysis module 110, and command management module 112.

The content editing module 106 is configured to perform actions based on user-uttered voice commands within a content recording, as described herein. The speech-to-text module 108 is configured to convert speech within an audio portion of the content recording into text, as described herein. The text analysis module 110 is configured to analyze the text to identify and track voice commands uttered by a user, as described herein. And the command management module 112 is configured to maintain commands of a user, as described herein.

Memory 604 may include content recordings 114 and edited content 116. The content recordings 114 may store one or more content recordings for a user. The edited content 116 may store one or more content recordings generated, created, or copied from the content recordings by employing embodiments described herein. Memory 604 may also store other programs 610, which may include operating systems, user applications, or other computer programs.

Network interfaces 624 is configured to communicate with other computing devices, such as content recording system 120. Network interfaces 624 include transmitters and receivers (not illustrated) to send and receive data between the user computing device 102 and the content recording system 120.

Other I/O interfaces 626 may include interfaces for various other input or output devices, such as audio interfaces, other video interfaces, USB interfaces, physical buttons, keyboards, haptic interfaces, tactile interfaces, or the like. Other computer-readable media 628 may include other types of stationary or removable computer-readable media, such as removable flash drives, external hard drives, or the like.

The following is a summarization of the claims as originally filed.

A method may be summarized as comprising: obtaining a content recording; converting audio of the content recording to text; analyzing the text to identify one or more voice commands of a user; determining an action to perform on the content recording based on the one or more voice commands; and automatically performing the action on the content recording in response to identifying the one or more voice commands in the text of the audio of the content recording.

The method may obtain the content recording by: receiving a plurality of separate content recordings; and aggregating the plurality of separate content recordings into the content recording.

The method may automatically perform the action on the content recording by: obtaining a current command and a previous command from the one or more voice commands; determining a segment name based on the text between the current command and the previous command; and maintaining the segment name for use with respect to a next command. In some embodiments, the method may further comprise: receiving the next command; and preserving a portion of the content recording relative to the next command with the maintained segment name.

The method may automatically perform the action on the content recording by: obtaining a current command and a previous command from the one or more voice commands; and preserving a portion of the content recording between the previous command and the current command.

The method may automatically perform the action on the content recording by: obtaining a current command and a previous command from the one or more voice commands; and applying a first offset to the previous command or a second offset to the current command.

The method may automatically perform the action on the content recording by: obtaining a current command and a previous command from the one or more voice commands; and removing a portion of the content recording between the previous command and the current command.

The method may automatically perform the action on the content recording by: obtaining a current command and a previous command from the one or more voice commands; extracting a portion of the text between the current command and the previous command; and storing the extracted portion of the text with the content recording.

The method may automatically perform the action on the content recording by: obtaining a current command from the one or more voice commands; determining an effect defined by the current command; and initiating the effect on the content recording.

The method may automatically perform the action on the content recording by: obtaining a current command from the one or more voice commands; determining, based on the current command, a quality of a portion of the content recording associated with the current command; and labeling the portion of the content recording with the determined quality.

The method may automatically perform the action on the content recording by: obtaining a current command from the one or more voice commands; determining a duration associated with the current command; and storing a copy of a portion of the content recording defined by the determined duration.

The method may further comprise: obtaining a current command and a previous command from the one or more voice commands; and in response to the current command being received within a threshold time from the previous command, disregarding the previous command.

A computing system may be summarized as comprising: a content recording system configured to capture and store at least one content recording; at least one memory collectively configured to store computer instructions; and a processor system configured to execute the computer instructions to: obtain a content recording from an aggregate of the at least one content recording; convert audio of the content recording to text; analyze the text to identify a current voice command of a user; determine an action to perform on the content recording based on the current voice command; and automatically perform the action on the content recording in response to identifying the current voice command in the text of the audio of the content recording.

The processor system of the computing system automatically performs the action on the content recording by executing the computer instructions to: analyze the text to identify a previous voice command of the user; determine a segment name based on the text between the current voice command and the previous voice command; and maintain the segment name for use with respect to a next command.

The processor system of the computing system automatically performs the action on the content recording by executing the computer instructions to: obtain a current command and a previous command from the one or more voice commands; and preserve a portion of the content recording between the previous command and the current command.

The processor system of the computing system automatically performs the action on the content recording by executing the computer instructions to: obtaining a current command and a previous command from the one or more voice commands; and removing a portion of the content recording between the previous command and the current command with the segment name.

The processor system of the computing system automatically performs the action on the content recording by executing the computer instructions to: obtain a current command and a previous command from the one or more voice commands; extract a portion of the text between the current command and the previous command; and store the extracted portion of the text with the content recording.

The processor system of the computing system automatically performs the action on the content recording by executing the computer instructions to: obtain a current command from the one or more voice commands; determine an effect defined by the current command; and initiate the effect on the content recording.

The processor system of the computing system automatically performs the action on the content recording by executing the computer instructions to: obtain a current command from the one or more voice commands; determine a duration associated with the current command; and store a copy of a portion of the content recording defined by the determined duration.

A non-transitory computer-readable storage medium may be summarized as storing instructions that, when executed by a processor system of a computing system, cause the processor system to perform actions, the actions comprising: obtaining a content recording; converting audio of the content recording to text; analyzing the text to identify one or more voice commands of a user; determining an action to perform on the content recording based on the one or more voice commands; and automatically performing the action on the content recording in response to identifying the one or more voice commands in the text of the audio of the content recording.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining a content recording;
converting audio of the content recording to text;
analyzing the text to identify one or more voice commands uttered by a user during recording of content;
determining an action to perform on the content recording based on the one or more voice commands; and
automatically performing the action on the content recording in response to identifying the one or more voice commands in the text of the audio of the content recording.

2. The method of claim 1, wherein obtaining the content recording comprises:
receiving a plurality of separate content recordings; and
aggregating the plurality of separate content recordings into the content recording.

3. The method of claim 1, wherein automatically performing the action on the content recording comprises:
obtaining a current command and a previous command from the one or more voice commands;
determining a segment name based on the text between the current command and the previous command; and
maintaining the segment name for use with respect to a next command.

4. The method of claim 3, further comprising:
receiving the next command; and
preserving a portion of the content recording relative to the next command with the maintained segment name.

5. The method of claim 1, wherein automatically performing the action on the content recording comprises:
obtaining a current command and a previous command from the one or more voice commands; and
preserving a portion of the content recording between the previous command and the current command.

6. The method of claim 1, wherein automatically performing the action on the content recording comprises:
obtaining a current command and a previous command from the one or more voice commands; and
applying a first offset to the previous command or a second offset to the current command.

7. The method of claim 1, wherein automatically performing the action on the content recording comprises:
obtaining a current command and a previous command from the one or more voice commands; and
removing a portion of the content recording between the previous command and the current command.

8. The method of claim 1, wherein automatically performing the action on the content recording comprises:
obtaining a current command and a previous command from the one or more voice commands;
extracting a portion of the text between the current command and the previous command; and
storing the extracted portion of the text with the content recording.

9. The method of claim 1, wherein automatically performing the action on the content recording comprises:
obtaining a current command from the one or more voice commands;
determining an effect defined by the current command; and
initiating the effect on the content recording.

10. The method of claim 1, wherein automatically performing the action on the content recording comprises:
obtaining a current command from the one or more voice commands;
determining, based on the current command, a quality of a portion of the content recording associated with the current command; and
labeling the portion of the content recording with the determined quality.

11. The method of claim 1, wherein automatically performing the action on the content recording comprises:
obtaining a current command from the one or more voice commands;
determining a duration associated with the current command; and
storing a copy of a portion of the content recording defined by the determined duration.

12. The method of claim 1, further comprising:
obtaining a current command and a previous command from the one or more voice commands; and
in response to the current command being received within a threshold time from the previous command, disregarding the previous command.

13. A computing system, comprising:
a content recording system configured to capture and store at least one content recording;
at least one memory collectively configured to store computer instructions; and
a processor system configured to execute the computer instructions to:
obtain a content recording from an aggregate of the at least one content recording;
convert audio of the content recording to text;
analyze the text to identify a current voice command of a user;
determine an action to perform on the content recording based on the current voice command; and
automatically perform the action on the content recording in response to identifying the current voice command in the text of the audio of the content recording.

14. The computing system of claim 13, wherein the processor system automatically performs the action on the content recording by executing the computer instructions to:
analyze the text to identify a previous voice command of the user;
determine a segment name based on the text between the current voice command and the previous voice command; and
maintain the segment name for use with respect to a next command.

15. The computing system of claim 13, wherein the processor system automatically performs the action on the content recording by executing the computer instructions to:
obtain a current command and a previous command from the one or more voice commands; and
preserve a portion of the content recording between the previous command and the current command.

16. The computing system of claim 13, wherein the processor system automatically performs the action on the content recording by executing the computer instructions to:
obtaining a current command and a previous command from the one or more voice commands; and
removing a portion of the content recording between the previous command and the current command with the segment name.

17. The computing system of claim 13, wherein the processor system automatically performs the action on the content recording by executing the computer instructions to:
obtain a current command and a previous command from the one or more voice commands;
extract a portion of the text between the current command and the previous command; and
store the extracted portion of the text with the content recording.

18. The computing system of claim 13, wherein the processor system automatically performs the action on the content recording by executing the computer instructions to:
obtain a current command from the one or more voice commands;
determine an effect defined by the current command; and
initiate the effect on the content recording.

19. The computing system of claim 13, wherein the processor system automatically performs the action on the content recording by executing the computer instructions to:
obtain a current command from the one or more voice commands;
determine a duration associated with the current command; and
store a copy of a portion of the content recording defined by the determined duration.

20. A non-transitory computer-readable storage medium that stores instructions that, when executed by a processor system of a computing system, cause the processor system to perform actions, the actions comprising:
obtaining a content recording;
converting audio of the content recording to text;
analyzing the text to identify one or more voice commands of a user;
determining an action to perform on the content recording based on the one or more voice commands; and
automatically performing the action on the content recording in response to identifying the one or more voice commands in the text of the audio of the content recording.
